(19) United States
(12) Patent Application Publication
(10) Pub. No.: US 2026/0204609 A1
(43) Pub. Date: Jul. 16, 2026

(54) FUEL CELL

(71) Applicant: COMMISSARIAT A L'ENERGIE ATOMIQUE ET AUX ENERGIES ALTERNATIVES, Paris (FR)

(72) Inventors: Jean-Philippe POIROT-CROUVEZIER, Grenoble cedex 09 (FR); Benoît MORIN, Grenoble cedex 09 (FR); Robin MURRU, Grenoble cedex 09 (FR)

(73) Assignee: COMMISSARIAT A L'ENERGIE ATOMIQUE ET AUX ENERGIES ALTERNATIVES, Paris (FR)

(21) Appl. No.: 19/138,470

(22) PCT Filed: Dec. 13, 2023
(86) PCT No.: PCT/EP2023/085685

§ 371 Date: Jun. 12, 2025

(30) Foreign Application Priority Data
Dec. 14, 2022 (FR) FR2213294

(51) Int. Cl. H01M 8/2465; H01M 8/04082; H01M 8/04119; H01M 8/0438; H01M 8/04746; H01M 8/249

(52) U.S. Cl. CPC H01M 8/2465; H01M 8/04156; H01M 8/04201; H01M 8/04388; H01M 8/04753; H01M 8/249

(57) ABSTRACT

A fuel cell system having a “ping-pong” architecture, wherein two groups of electrochemical cells are supplied alternatively by a fluid circuit comprising at least one expansion member and two switching members on the supply lines of the groups. Advantageously, the switching members are formed by injectors configured to expand the supply fluid coming from a main conduit The injectors make it possible both to expand the fluid and to enable or to block a passage of the fluid to the inlets of the groups.

### TECHNICAL FIELD OF THE INVENTION

The present invention relates to the field of fuel cells, in particular, proton exchange membrane fuel cells (PEMFC). It can be implemented to condition or activate a PEMFC and optimise the performance of it.

### PRIOR ART

A fuel cell is formed of a stack of “unitary” electrochemical cells, each comprising an anode and a cathode, electrically separated from one another by an electrolyte. In the case of a hydrogen cell, the fuel (hydrogen) is brought into contact with the anode, and the comburant (oxygen) is brought into contact with the cathode. Oxidation and reduction reactions occur respectively at the anode and at the cathode, which produces electricity, water and heat. The electrolyte can be presented in the form of a membrane, letting the protons coming from the oxidation reaction of hydrogen pass. This is the case of proton exchange membrane fuel cells (PEMFC).

The stack of cells is only the location of the reaction: the reagents must be brought there, the products and the non-reactive species must be discharged from there, just like the heat produced. Generally separated fluid circuit make it possible to supply the stack of cells respectively with fuel and with comburant, and to discharge the products coming from the stack.

When the fuel is hydrogen, the latter can come from a pressurised reservoir. The fluid circuit intended to bring hydrogen to the anode thus comprises one or more expansion stages, making it possible to decrease the hydrogen pressure at the inlet of the stack of cells.

The fluid circuit can be more complex in the case of particular cell architectures. In the so-called “ping-pong” architecture disclosed by patent document FR2975227, the cell is divided into several groups of cells in fluid connection with one another by their respective outlets.

In this known architecture illustrated in FIG. 1, the supply at the inlet 11, 21 of the different groups 10, 20 is done alternatively during certain operating phases of the cell. A first group 10 is supplied at the inlet 11 by the combustible fluid (hydrogen), while the supply of a second group 20 is cut off at the inlet 21. The combustible fluid passes through the first group, which thus operates nominally, and exits humidified and slightly depleted at the outlet 12 of the first group 10. This fluid then supplies the second group 20 by the outlet 22 of the second group 20. This direct supply of the first group and in the opposite direction of the second group makes it possible to dissipate highly depleted fluid pockets formed within the cells of the first group. This avoids the cells of the first group operating in an extended manner, in the presence of a highly depleted stagnant fluid. The second group 20 is then supplied at the inlet 21 by the combustible fluid, while the supply of the first group 10 is cut off at the inlet 11. The combustible fluid passes through the second group, which thus operates nominally, and exits humidified and slightly depleted at the outlet 22 of the second group 20. This fluid then supplies the first group 10 by the outlet 12 of the first group 10. This direct supply of the second group and in the opposite direction of the first group also makes it possible to dissipate highly depleted fluid pockets formed within the cells of the second group during the preceding cycle. This avoids the cells of the second group operating in an extended manner, in the presence of a highly depleted stagnant fluid.

The principle of this ping-pong architecture consists of alternatively supplying the different groups of cells, so as to alternate nominal operating phases with supply phases in the opposite direction.

The fluid circuit 3, 4 of such an architecture thus comprises a supply line 100, 200 distinct for each group 10, 20 and one switching valve 101v, 201v per supply line 100, 200. The fluid circuit of such a fuel cell is relatively big. This increases the total size of the cell.

An aim of the present invention is therefore to propose a fuel cell having a reduced size, in particular, at the fluid circuit.

Other aims, features and advantages of the present invention will appear upon examining the description below and the accompanying drawings. It is understood that other advantages can be incorporated.

### SUMMARY OF THE INVENTION

To achieve this aim, according to an embodiment, a fuel cell is provided, comprising:
a first group of electrochemical cells having a first inlet and a first outlet,
a second group of electrochemical cells having a second inlet and a second outlet,
a fluid circuit intended to supply, by a fluid, said first and second groups, and to discharge said fluid from said first and second groups.

The fluid circuit comprises a so-called upstream part, comprising:
a main supply conduit configured to drive the fluid at a so-called medium pressure, and connected to secondary supply lines,
a first secondary supply line connected to the main supply conduit and connected to the first inlet of the first group,
a second secondary supply line connected to the main supply conduit and connected to the second inlet of the second group.

The fluid circuit comprises a so-called downstream part, comprising:
a main discharge conduit connected to secondary discharge lines, and configured to be connected to an exhaust,
a first secondary discharge line connected to the first outlet of the first group, to the main discharge conduit, and to the second outlet of the second group, so as to enable a fluid supply of the second group via the second outlet, by the fluid having passed through the first group,
a second secondary discharge line connected to the second outlet of the second group, to the main discharge conduit, and to the first outlet of the first group, so as to enable a fluid supply of the first group via the first outlet, by the fluid having passed through the second group.

The cell further comprises:
at least one expansion member located in the upstream part of the fluid circuit, configured to decrease the pressure of the fluid coming from the reservoir, from the medium pressure to a low pressure,
a first switching member on the first secondary supply line, configured to enable or block a flow of the fluid to the first inlet,
a second switching member on the second secondary supply line, configured to enable or block a flow of the fluid to the second inlet,
preferably, a draining member on the main discharge conduit, configured to enable or block a flow of the fluid to the exhaust.

Advantageously, the at least one expansion member comprises a first expansion member on the main supply conduit, configured to decrease the pressure of the fluid coming from the reservoir, from the high pressure to a medium pressure.

Advantageously, the first switching member is formed by a first injector enabling or blocking the flow of the fluid to the first inlet and configured to decrease the pressure of the fluid coming from the first expansion member, from the medium pressure to a first low pressure.

Advantageously, the second switching member is formed by a second injector enabling or blocking the flow of the fluid to the second inlet and configured to decrease the pressure of the fluid coming from the first expansion member, from the medium pressure to a second low pressure.

Thus, the at least one expansion member is formed by the first and second injectors.

Thus, the first and second injectors ensure both an expansion role of the fluid, from the medium pressure to respectively the first and second low pressures, and a switching role to enable or block the flow of the fluid to respectively the first and second inlets of the first and second groups.

In a conventional ping-pong architecture such as illustrated in FIG. 1, the expansion of the fluid is done, in practice, by means of two pressure relief valves 31, 32 mounted on the main supply conduit 300 ensuring successively a first expansion from high pressure to medium pressure, then a second expansion from medium pressure to low pressure. To preserve a constant volume flow rate of fluid, the cross-section 300a of the main supply conduit increases at the outlet of the first pressure relief valve 31 (high pressure-medium pressure) and further increases at the outlet of the second pressure relief valve 32 (medium pressure-high pressure). This increased cross-section 300b is then constant along the secondary supply lines 100, 200 provided with switching valves 101v, 201v.

In the scope of development of the present invention, it has been identified that the size of the fluid circuit of the conventional ping-pong architecture was linked:
To the number of expansion 31, 32 and switching 101v, 102v members,
To the size of the second pressure relief valve 32 requiring a very large membrane to pass from medium pressure to low pressure,
To the large cross-section 300b of the parts of the fluid circuit 3, where the fluid circulates at low pressure.

By replacing the second pressure relief valve 32 with an injector, the compactness of the fluid circuit is already improved. An injector indeed has a high-pressure loss coefficient, compatible with a good compactness.

In the scope of the present invention, however, it has been observed that the injector could also ensure a switching function, a function which is usually devoted to on/off valves. Due to this, instead of replacing the second pressure relief valve with an injector as a person skilled in the art would have been able to do, it has been decided to remove the second pressure relief valve and to replace the switching valves on each of the secondary supply lines with injectors. Thus, the number of members of the fluid circuit is decreased. An assembly of two switching valves and one medium pressure-low pressure relief valve in the case of the conventional ping-pong architecture is passed from, to an assembly of two injectors in the case of the ping-pong architecture according to the invention. The compactness of the circuit is therefore further improved. This further simplifies the design of the fluid circuit and the management of the different members. The energy consumption of the fluid circuit is also reduced, since it is sufficient to electrically supply one single injector out of the two, alternately, to supply the fuel cell having the ping-pong architecture according to the invention with combustible fluid. On the contrary, in the case of conventional ping-pong architecture, it is necessary to permanently electrically supply two members for the expansion and the switching, these functions being performed separately.

The use of injectors instead of switching valves, and the removal of the second pressure relief valve, also makes it possible to shorten the total circuit length having a large cross-section for the circulation of the low-pressure fluid. Indeed, only the parts of the fluid circuit located respectively between the first injector and the first inlet, on the first secondary supply line, and between the second injector and the second inlet, on the second secondary supply line, effectively require a large cross-section compatible with the low-pressure combustible fluid flow rate. The total size of the fluid circuit is further decreased. By its reduced size, the injector can, in addition, be partially or totally integrated in the cell inlet, which can totally remove the need for low pressure pipes.

Further to their improved compactness, these injectors have a great operating reliability, and an improved reactivity, enabling an easy adjustment of the setpoint pressure.

Consequently, and advantageously, the fuel cell having a ping-pong architecture according to the present invention makes it possible, in particular, to increase compactness, to simplify the combustible fluid (hydrogen) supply line, and to reduce the energy consumption dedicated to the combustible fluid injection.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIG. 1 represents a fuel cell having a ping-pong architecture according to the prior art.

FIG. 2A represents a fuel cell having a ping-pong architecture according to a first operating phase, according to a first embodiment of the present invention.

FIG. 2B represents a fuel cell having a ping-pong architecture according to a second operating phase, according to a first embodiment of the present invention.

FIG. 2C represents a fuel cell having a ping-pong architecture according to a third operating phase, according to a first embodiment of the present invention.

FIG. 3 represents a fuel cell having a ping-pong architecture according to a second embodiment of the present invention.

FIG. 4 represents a fuel cell having a ping-pong architecture according to a third embodiment of the present invention.

The drawings are given as examples and are not limiting of the invention. They constitute principle schematic representations, intended to facilitate the understanding of the invention, and are not necessarily to the scale of practical applications. In particular, the different members and the different parts of the fluid circuit are illustrated by diagrams, which are not representative of reality.

### DETAILED DESCRIPTION OF THE INVENTION

Before starting a detailed review of embodiments of the invention, optional features are stated below, which can optionally be used in association or alternatively:

According to an example, the fuel cell system comprises:
a first group of electrochemical cells having a first inlet and a first outlet,
a second group of electrochemical cells having a second inlet and a second outlet,
a fluid circuit intended to supply said first and second groups with a fluid, and to discharge said fluid from said first and second groups, and

The fluid circuit comprises a so-called upstream part, comprising:
a main supply conduit configured to be connected to a reservoir storing the fluid at a pressure P1, called high pressure, and connected to secondary supply lines,
a first secondary supply line connected to the main supply conduit and connected to the first inlet of the first group,
a second secondary supply line connected to the main supply conduit and connected to the second inlet of the second group, and

The fluid circuit comprises a so-called downstream part, comprising:
a main discharge conduit connected to secondary discharge lines, and configured to be connected to an exhaust,
a first secondary discharge line connected to the first outlet of the first group, to the main discharge conduit, and to the second outlet of the second group, so as to enable a fluid supply of the second group via the second outlet, by the fluid having passed through the first group,
a second secondary discharge line connected to the second outlet of the second group, to the main discharge conduit, and to the first outlet of the first group, so as to enable a fluid supply of the first group via the first outlet, by the fluid having passed through the second group, and

The cell further comprises:
at least one expansion member located in the upstream part of the fluid circuit, configured to decrease the pressure of the fluid coming from the reservoir, from the high pressure to a low pressure,
a first switching member on the first secondary supply line, configured to enable or block a flow of the fluid to the first inlet,
a second switching member on the second secondary supply line, configured to enable or block a flow of the fluid to the second inlet,
preferably, a draining member on the main discharge conduit, configured to enable or block a flow of the fluid to the exhaust.

According to an example, the at least one expansion member comprises a first expansion member on the main supply conduit, configured to decrease the pressure of the fluid coming from the reservoir, from the high pressure to a medium pressure.

According to an example, the first switching member is formed by a first injector configured to decrease the pressure of the fluid coming from the first expansion member, from the medium pressure to a first low pressure.

According to an example, the second switching member is formed by a second injector configured to decrease the pressure of the fluid coming from the first expansion member, from the medium pressure to a second low pressure.

According to an example, the first and second injectors are regulated in pressure respectively by first and second sensors located respectively on the first and second secondary supply lines. Each of the injectors is thus connected to its own sensor. This enables an independent regulation of the injectors.

According to an example, the first and second injectors are regulated in pressure by a sensor located in the downstream part of the fluid circuit, for example, on the main discharge conduit, typically between the first and second outlets and the draining member. The regulation of the injectors is thus done via a downstream measurement of the cell. This measurement is more representative of real pressures within the groups of the cell. The measurement is thus more reliable, and the pressure control can be more accurate. Moreover, one single sensor makes it possible, in this case, to regulate the injection in the two groups. This minimises the number of members present on the fluid circuit. The compactness of the cell is improved.

According to an example, the sensor is positioned such that, for the given constant supply conditions of the first group or of the second group, the sensor measures one same constant pressure.

According to an example, the sensor is positioned at an equal distance from the first and second outlets of the first and second groups.

According to an example, the cell further comprises a controller configured to control the first and second injectors, according to a pressure measurement of the sensor and optionally, of a pressure loss model established for the first and second groups of electrochemical cells. This improves the regulation of the first and second injectors. Such a model can consider parameters which are complementary to the pressure losses, like for example, the temperature of the cell or the current density.

According to an example, the fluid circuit further comprises, in the upstream part:
A third secondary supply line in parallel with the first secondary supply line, connected to the main supply conduit and connected to the first inlet of the first group,
A fourth secondary supply line in parallel with the second secondary supply line, connected to the main supply conduit and connected to the second inlet of the second group.

According to an example, the cell further comprises:
A third injector on the third secondary supply line, enabling or blocking the flow of the fluid to the first inlet, and configured to decrease the pressure of the fluid coming from the main supply conduit, from the medium pressure to a third low pressure,
A fourth injector on the fourth secondary supply line, enabling or blocking the flow of the fluid to the second inlet, and configured to decrease the pressure of the fluid coming from the main supply conduit, from the medium pressure to a fourth low pressure.

The first and second secondary supply lines are thus doubled or seconded by the third and fourth secondary supply lines, respectively. The term “parallel” does not necessarily mean that these secondary supply lines have structures which are parallel to one another. The term “parallel” does not mean “structurally parallel”. It means that the mounting of these secondary supply lines is done in parallel. It also means that these secondary supply lines are comparable to one another. A third secondary supply line provided with a third injector enables a redundancy of material with the first secondary supply line provided with the first injector. A fourth secondary supply line provided with a fourth injector enables a redundancy of material with the second secondary supply line provided with the second injector. This improves the reliability of the cell. This also makes it possible to extend the range of flow rates accessible for the first and second groups of cells. This also limits pressure oscillations at the inlet of the groups of the cell. The third and fourth secondary supply lines are not necessarily identical to the first and second secondary supply lines. The third and fourth injectors are not necessarily identical to the first and second injectors. Injectors sized differently from one another, for example, a large injector and a small injector in parallel, typically make it possible to scan the flow rate range with less pressure oscillations. Two identical injectors in parallel typically make it possible to double the flow rate range.

According to an example, the first, second, third and fourth injectors are regulated in pressure by a sensor located on the downstream part of the fluid circuit, for example, on the main discharge conduit, typically between the first and second outlets and the draining member. This minimises the numbers of members present on the fluid circuit. The compactness of the cell is improved.

According to an example, the cell further comprises an additional sensor intended to supplement the sensor located on the downstream part of the fluid circuit. The additional sensor forms a redundancy with the sensor located on the downstream part of the fluid circuit. This improves the reliability of the cell.

According to an example, the main supply conduit is connected to a first expansion member configured to decrease the pressure of the fluid coming from a reservoir storing the fluid at a pressure called high pressure, from high pressure to medium pressure.

According to an example, the first expansion member is formed by an injector which is different from the first and second injectors. This improves the compactness of the fluid circuit. An injector is more compact than a pressure relief valve.

According to an example, the first expansion member is a simple pressure relief valve.

According to an example, the secondary supply lines only comprise one or more injectors, with optionally their associated sensors, without switching valves. According to an example, the secondary supply lines are directly connected to the main supply conduit and to the inlets of the groups considered.

Unless incompatible, technical features described in detail for a given embodiment can be combined with the technical features described in the context of other embodiments described as examples and in a non-limiting manner. In particular elements described or illustrated for certain embodiments of the cell can be combined, so as to form another embodiment, which is not necessarily illustrated or described. Such an embodiment is clearly not excluded from the invention. A fuel cell according to the present invention comprises at least two groups of electrochemical cells. A person skilled in the art will have no difficulty in implementing an embodiment comprising more than two groups of electrochemical cells.

In the scope of the present invention, by “ping-pong architecture fuel cell system”, this means a system comprising at least two groups of electrochemical cells distributed in one or more stacks. Each group is thus constituted of a series of electrically and fluidically interconnected electrochemical cells. The cells are typically presented in the form of a membrane electrode assembly, commonly called MEA. The cell comprises, in this case, at least five stacked cells, and preferably, at least ten.

The ping-pong architecture cell system typically has different operating phases, in particular, a first phase during which a first group is supplied directly by a first injector, the second group being supplied only by the gas exiting from the first group, a second phase during which the second group is supplied directly by a second injector, the first group being supplied only by the gas exiting from the second group, a simultaneous third operating phase of the first and second groups and/or a draining phase. The first and second phases are carried out alternately. The third operating phase and/or the draining phase succeed the first and second phases.

The terms “high pressure”, “medium pressure” and “low pressure” are perfectly clear for a person skilled in the art. A high pressure is strictly greater than a medium pressure. A medium pressure is strictly greater than a low pressure. A high pressure is generally greater than 50 bars, even greater than 100 bars. A high pressure can reach up to 700 bars, even more, according to conditions. A medium pressure is generally of between 5 and 40 bars, typically between 5 and 20 bars. A low pressure is generally less than 4 bars. In the scope of the present invention, an inlet or an outlet of a group of the cell, typically each have a structural aspect and an operational aspect. Thus, structurally, the inlet and the outlet correspond to first and second passage orifices for the combustible fluid. Operationally, the inlet and the outlet respectively designate the intake and the discharge of the combustible fluid. Insofar as the circulation direction of the fluid within the group is alternatively inverted, the inlet and the outlet can be operationally inverted. Thus, the first passage orifice can form the inlet or the outlet operationally, and conversely, the second passage orifice can form the outlet or the inlet operationally.

To facilitate understanding regarding the circulation of fluid in the cells of the cell, only the terms inlet/outlet and their corresponding references on the accompanying drawings, respectively X1 (X=1 . . . 2) for the inlet and X2 (X=1 . . . 2) for the outlet are preserved, independently from their operational assignment.

In the scope of the present invention, the outlets of the groups are in fluid communication with one another, via the secondary discharge lines specific to each of the groups. Each secondary discharge line extends between the outlet of the group considered and a common main discharge conduit. Each secondary discharge line can borrow sections from other lines, for example, other secondary discharge lines. Thus, sections of a given secondary discharge line can be common with sections of other secondary discharge lines. Tapping points or junctions can be physically present along the secondary discharge line(s). Members can also be present along these secondary discharge lines, for example, regulation members. All of the secondary discharge lines can form an outlet collector of the cell connected to the main discharge conduit of the cell.

The operation of the cell according to the invention is based on a succession of supply and/or discharge phases which are different from one another. Unless explicitly mentioned, the terms “succession” or “successive” does not necessarily imply, even if this is generally preferred, that the phases immediately follow one another, intermediate phases or steps being able to separate them.

In the accompanying figures, a circulation direction of the fluid in the fluid circuit is indicated by an arrow. The dotted lines illustrate data connections, typically between the sensors and the injectors, the valves or the pressure relief valves. In the accompanying figures, for clarity, the cell system illustrated comprises one single cell comprising two groups. It is understood that the description of this cell extends to the cell system and to all the variants in number of cells, of groups, etc.

In the examples below, the fuel cell is described and illustrated for a ping-pong architecture comprising two groups of substantially identical cells. It can, however, be fully considered, to implement more than two groups and/or groups which are sized differently, without departing from the general fluid circuit principle explained below. The groups can also be distributed in different cells, fluidically connected to one another.

The original idea implemented in the scope of the development of the present invention consists, in particular, of replacing members, separately ensuring the expansion and the switching along the fluid circuit, by one single member, ensuring both the expansion and the switching, in particular, by an injector. This makes it possible to increase in compactness, in reactivity and in reliability.

It has, in particular, been observed, that it was not necessary to use switching valves to ensure the switching function in the fluid circuit, contrary to a technical prejudice. This function is advantageously achieved by an injector.

A hydrogen injector is typically a solenoid valve, sized to obtain opening/closing cycles over very short times, of around one hundredth or one tenth of a second up to one second. This member enables the injection of a pulsed hydrogen flow with a variable flow rate and with an improved reactivity, for example, regarding a regulated proportional solenoid valve. Its operation requires the application of a pressure difference of a few bars, between the inlet and the outlet of the injector, in particular, so as to obtain an extended flow rate range. The injectors are significantly more compact than the membrane pressure relief valves. The regulation of pressure by an injector is done, typically by adapting the ratio of the opening/closing cycles of the operating injector.

In the scope of the present invention, an injector has at least one pressure regulation function, in particular to expand a medium pressure to a low pressure, and at least one hashing or switching function. By opposition, a switching valve has one single hashing or switching function.

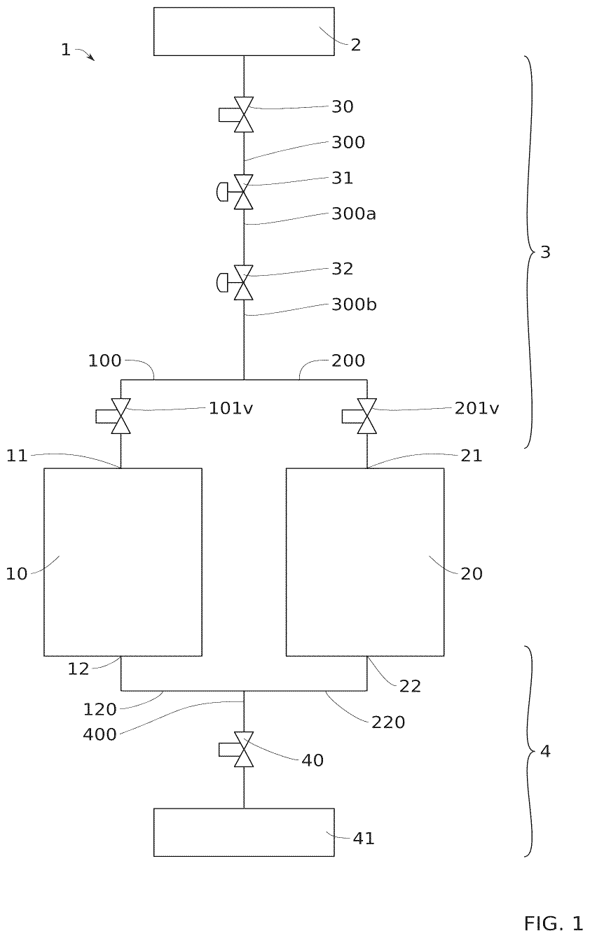

As mentioned above, FIG. 1 illustrates a fuel cell 1 having a ping-pong architecture according to the prior art. It is connected to a high-pressure hydrogen reservoir 2 and comprises a fluid circuit composed of a part 3 upstream from the groups 10, 20 of electrochemical cells, and a part 4 downstream from the groups 10, 20 of electrochemical cells.

The upstream part 3 according to the prior art comprises a stop valve 30 at the outlet of the reservoir 2, a main supply conduit 300 on which are successively mounted, a first pressure relief valve 31 and a second pressure relief valve 32. The first pressure relief valve 31 makes it possible to decrease the pressure of the fluid coming from the reservoir 2 from a so-called high pressure of around a few hundreds of bars to a so-called medium pressure of around a few tens of bars. Consequently, the cross-section of the main supply conduit 300a increases at the outlet of the first pressure relief valve 31. The second pressure relief valve 32 makes it possible to decrease the pressure of the fluid coming from the first pressure relief valve 31 from the medium pressure to a so-called low pressure of around a few bars. Consequently, the cross-section of the main supply conduit 300b increases at the outlet of the second pressure relief valve 32.

The upstream part 3 of the fluid circuit according to the prior art also comprises a first secondary supply line 100 connecting the main supply conduit 300b to the inlet 11 of the first group 10 of electrochemical cells, and a second secondary supply line 200 connecting the main supply conduit 300b to the inlet 21 of the second group 20 of electrochemical cells. The first and second secondary supply lines 100, 200 comprise respectively a first switching valve 101v and a second switching valve 201v ensuring either the passage, or the blocking of the fluid to each of said groups 10, 20.

The downstream part 4 of the fluid circuit according to the prior art comprises a first secondary discharge line 120 connecting the outlet 12 of the first group 10 of electrochemical cells to the main discharge conduit 12 of the first group 10 of electrochemical cells to the main discharge conduit 400, and a second secondary discharge line 220 connecting the outlet 22 of the second group 20 of electrochemical cells to the main discharge conduit 400. The first and second secondary discharge lines 120, 220 typically form an outlet collector of the cell 1. The main discharge conduit 400 is connected to an exhaust 41 and is provided with a draining valve 40.

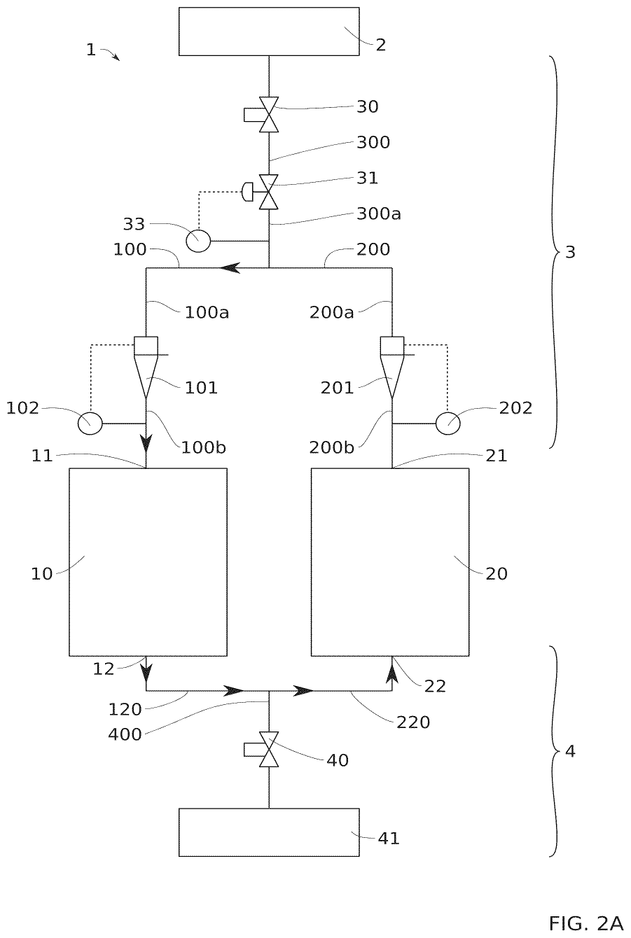

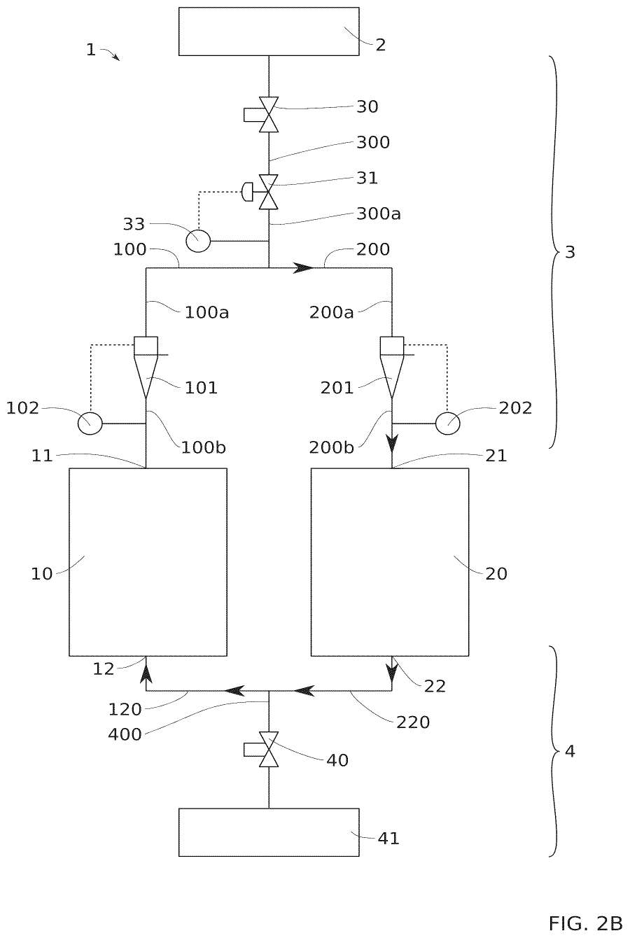

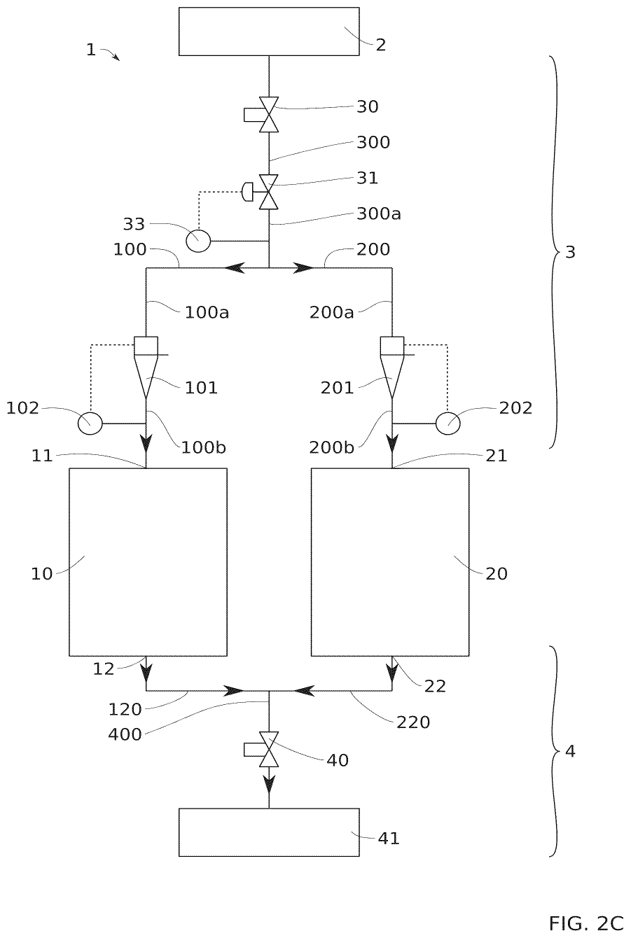

FIG. 2A illustrates a first embodiment of a ping-pong architecture fuel cell according to the invention, returning to certain elements of the fuel cell illustrated in FIG. 1. In particular, the groups 10, 20 of electrochemical cells and the downstream part 4 of the fluid circuit are substantially identical to those of the prior art. Preferably, the two groups 10, 20 of cells have the same number of cells, but they can also be different. The groups 10, 20 can be overlapped in one single and same stack, with an alternance of cells of the first group and of the second group, as described in patent document FR2975227.

In this first embodiment illustrated in FIG. 2A, the modifications regarding the prior art are located in the upstream part 3 of the fluid circuit.

The upstream part 3 according to the first embodiment of the invention preferably comprises a stop valve 30 at the outlet of the reservoir 2, a main supply conduit 300 on which is mounted a first pressure relief valve 31, preferably one single and unique first pressure relief valve 31, for example, a two-stage pressure relief valve 31, optionally regulated by a pressure sensor 33, and configured to decrease the pressure of the fluid coming from the reservoir 2 from high pressure to medium pressure. The cross-section of the main supply conduit 300a increases at the outlet of the first pressure relief valve 31. It must be noted that the presence of high-pressure fluid and the need for expansion by the pressure relief valve 31 to medium pressure is linked to a supply event by a high-pressure reservoir 2. In the case of a supply of another type, for example, a medium pressure storage or via a gas network, this supply can be done directly at medium pressure by an interconnection on the main supply conduit 300a.

The upstream part 3 of the fluid circuit according to the first embodiment of the invention also comprises a first secondary supply line 100a, 100b connecting the main supply conduit 300a at the inlet 11 of the first group 10 of electrochemical cells, and a second secondary supply line 200a, 200b connecting the main supply conduit 300a to the inlet 21 of the second group 20 of electrochemical cells. The first and second secondary supply lines 100, 200 comprise respectively a first injector 101 and second injector 102.

The first and second injectors 101, 201 advantageously make it possible to:
Decrease the pressure of the fluid coming from the first pressure relief valve 31 from the medium pressure to, respectively, a first low pressure and a second low pressure,
Enable or block the passage of the fluid to, respectively, the first inlet 11 and the second inlet 21.

Each injector 101, 201 thus fulfils both the function of a pressure relief valve and a switching valve. The first and second injectors 101, 201 are preferably regulated in pressure, respectively by sensors 102, 202 located downstream from the injectors 101, 201, respectively on the first and second secondary supply lines 100b, 200b. A high-frequency opening/closing cycle (up to several cycles per second) can be applied to each injector 101, 201 according to the difference between the pressure setpoint and the pressure value measured downstream by the sensors 102, 202. This makes them more reactive, flexible and accurate regarding the desired conditions for the cell.

According to an option, the first and second injectors 101, 201 are substantially identical and the first low pressure is substantially equal to the second low pressure. According to another option, the first and second injectors 101, 201 can be sized differently from one another, and the first low pressure can be different from the second low pressure.

Advantageously, the cross-section of the first secondary supply line 100a upstream from the injector 101 is substantially the same as that of the main supply conduit 300a. In the same way, the cross-section of the second secondary supply line 200a upstream from the injector 201 is substantially the same as that of the main supply conduit 300a. Only the secondary supply lines 100b, 200b downstream from the first and second injectors 101, 201 have an increased cross-section, capable of driving a low-pressure fluid constant volume flow rate. The total size of the upstream part 3 of the fluid circuit is thus reduced. FIG. 2A illustrates a first operating phase of the cell 1, in which only the first group 10 is supplied with combustible fluid. In this configuration, the first injector 101 is in operation, while the second injector 201 is closed. The operation of the first injector 101 typically corresponds to a rapid alternance of openings and closings. The draining valve 40 is closed. As illustrated by the arrows along the fluid circuit, the combustible fluid coming from the reservoir 2 first passes through the first pressure relief valve 31. The combustible fluid thus has, at the outlet of the first pressure relief valve 31, a medium pressure of around 5 to 20 bars (typically 6 to 8 bars). The combustible fluid is thus driven into the inlet 11 of the first group 10 by the first secondary supply line 100a, 100b, through the first injector 101. The combustible fluid thus has, at the outlet of the first injector 101, a first low pressure less than 4 bars. The combustible fluid then passes through the first group 10 then successively borrows the first secondary discharge line 120, the second secondary discharge line 220, and reaches the second group 20 through the outlet 22.

FIG. 2B illustrates a second operating phase of the cell 1, in which only the second group 20 is supplied with combustible fluid. In this configuration, the first injector 101 is closed and the second injector 201 is in operation. The operation of the second injector 201 typically corresponds to a rapid alternance of openings and closings. The draining valve 40 is closed. As illustrated by the arrows along the fluid circuit, the combustible fluid coming from the reservoir 2 first passes through the first pressure relief valve 31. The combustible fluid thus has, at the outlet of the first pressure relief valve 31, a medium pressure of around 5 to 20 bars (typically 6 to 8 bars). The combustible fluid is thus driven into the inlet 21 of the second group 20 by the second secondary supply line 200a, 200b, through the second injector 201. The combustible fluid thus has, at the outlet of the second injector 201, a second low pressure less than 4 bars. The combustible fluid then passes through the second group 20, then successively borrows the second secondary discharge line 220, the first secondary discharge line 120, and reaches the first group 10 through the outlet 12.

The transition between the first and second phases can be instantaneous or be done with an offset. If a transition is passed through, where the two injectors 101, 201 are closed, this transition is preferably short (around a few milliseconds, for example), to avoid a drop in pressure in the cell. In the same way, if the two injectors 101, 201 are in operation simultaneously during the transition, its duration is preferably short (around one second) to avoid shifting into a “dead-end”-type operating mode.

FIG. 2C illustrates a third operating phase of the cell 1, in which the first and second groups 10, 20 are supplied simultaneously with combustible fluid. In this configuration, the first injector 101 is in operation and the second injector 201 is in operation. The draining valve 40 is either open to discharge the fluid and the reaction products to the outside, or closed to accumulate certain products or reagents, for example, nitrogen. As illustrated by the arrows along the fluid circuit, the combustible fluid coming from the reservoir 2 first passes through the first pressure relief valve 31. The combustible fluid thus has, at the outlet of the first pressure relief valve 31, a medium pressure of around 5 to 20 bars (typically 6 to 8 bars). A part of the combustible fluid is thus driven into the inlet 11 of the first group 10 by the first secondary supply line 100a, 100b, through the first injector 101, and another part of the combustible fluid is driven into the inlet 21 of the second group 20 by the second secondary supply line 200a, 200b, through the second injector 201. The combustible fluid thus has, at the outlet of the first injector 201, a first low pressure less than 4 bars. The combustible fluid thus has, at the outlet of the second injector 201, a second low pressure less than 4 bars. The combustible fluid then passes through, respectively, the first and second groups 10, 20 then borrows the first and second secondary discharge lines 120, 220, up to the main discharge conduit 400. The combustible-depleted fluid can be accumulated in the downstream part 4 of the fluid circuit, if the draining valve 40 is closed, or discharged to the exhaust 41, if the draining valve 40 is open.

Using two injectors 101, 201 instead of conventional switching valves upstream from the inlets 11, 21 of each group 10, 20 advantageously makes it possible to apply pressure setpoints which are different and/or variable over time to the groups 10, 20, during different operating phases of the cell 1. It is thus possible to apply pressure setpoints for the first injector 101 and for the second injector 201. It is also possible to progressively decrease the pressure at the end of the first operating phase (respectively, at the end of the second operating phase). This makes it possible to increase the pressure difference in the fluid circuit, and within the groups 10, 20 between the end of the first operating phase and the start of the second operating phase succeeding it. The fluid flow rate is thus increased. This makes it possible to improve the movement of the liquid phase in the groups 10, 20 of cells. Moreover, if performance differences appear between the two groups 10, 20 of cells, applying different pressures during the first and second phases can overcome this problem. Using two injectors 101, 201 therefore advantageously provides more reactivity and operating flexibility for the operation of the cell 1. The operation of the injectors is also advantageously independent of the fluid flow rate, which has high variations in a fuel cell. These flow rate variations can generate inaccuracies in the performance of the pressure relief valve 31, which can be corrected by the injectors 101, 201 through controlling these. The injectors therefore make it possible to simplify the pressure control of the cell. This is all the more true when the pressure relief valve 31 does not have a regulation by a downstream sensor 33, an element of saving and simplicity for the system.

Structurally, the main discharge conduit 400 common to the two groups 10, 20 can be included in the stack of groups 10, 20 of cells, as described in document FR2975227. It thus acts as a phase separator and makes it possible to collect liquid water. A dedicated member can be added to improve the effectiveness of this separation, for example, a porous material, one or more baffles, etc.

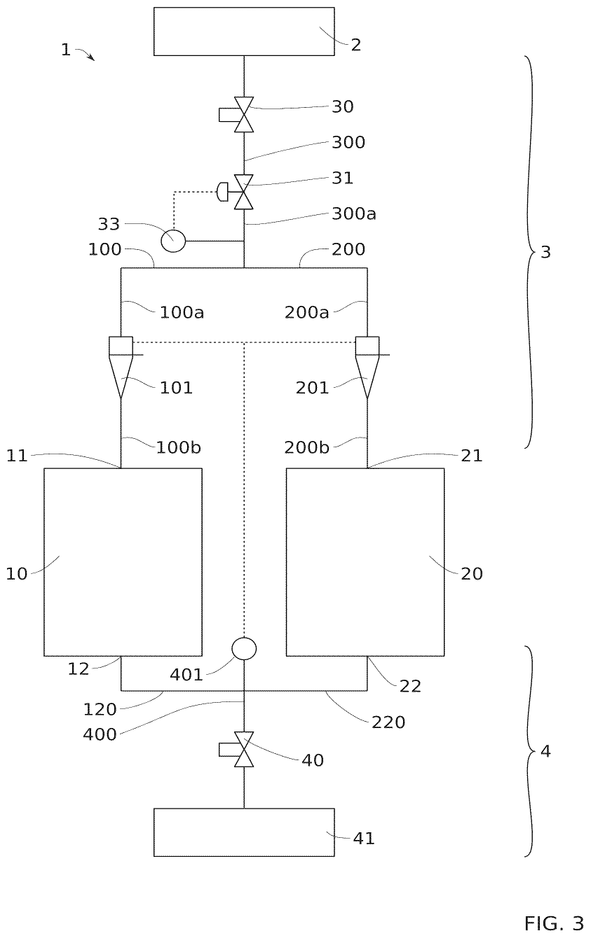

FIG. 3 illustrates a second embodiment of a ping-pong architecture fuel cell according to the invention. Only the different features of this second embodiment regarding the first embodiment are described below. The other features are considered identical to those of the first embodiment.

In this second embodiment, the first and second injectors 101, 201 are no longer each associated with an independent pressure sensor. One single pressure sensor 401, mounted on the downstream part 4 of the fluid circuit at the outlet of the first and second groups 10, 20, is used to regulate the first and second injectors 101, 201. This makes it possible to limit the number of pressure sensors, and therefore to decrease the costs and improve the compactness of the cell 1. Controlling the first and second injectors 101, 201 is also simplified. In this position of the sensor 401, the pressure measurement is taken, preferably halfway between the outlet of the group 10 and the outlet of the group 20. If the two groups 10, 20 are identical, this makes it possible to measure one same pressure value, independently from the supplied group.

As the sensor 401 is, in this case, mounted on the downstream part 4 of the fluid circuit, it can be advantageous to introduce a pressure loss model in the two groups 10, 20 of cells, for the control and command of the injectors 101, 201. This improves the regulation of the injectors 101, 201. This pressure loss model can be established from an accurate characterisation of the fluid performance of the groups 10, 20 of cells. One or more injection controller(s) (not illustrated), configured to control the injectors 101, 201, can typically consider this pressure loss model for controlling and commanding the injectors 101, 201.

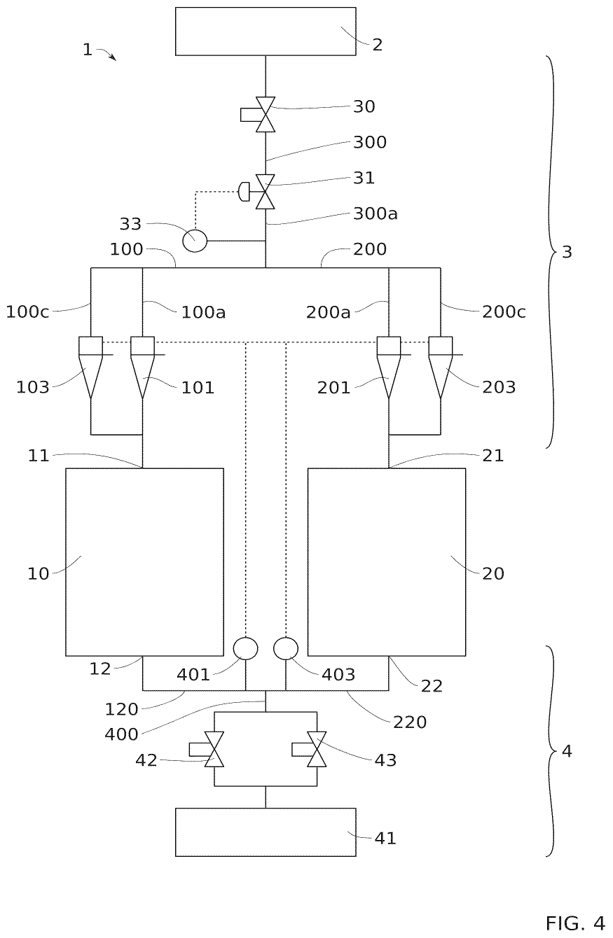

FIG. 4 illustrates a third embodiment of a ping-pong architecture fuel cell according to the invention. Only the different features of the third embodiment regarding the first embodiment or the second embodiment are described below. The other features are considered identical to those of the first embodiment or of the second embodiment.

In this third embodiment, two injectors are mounted parallel on each of the secondary supply lines. This makes it possible to both obtain a redundancy of material, in case of failure of one of the injectors, for example, and to increase the range of flow rates for each group 10, 20. Thus, the first secondary supply line 100 is divided into two branches 100a, 100c carrying, respectively, the injectors 101, 103, each supplying the inlet 11 of the first group 10. The second secondary supply line 200 is also divided into two branches 200a, 200c carrying, respectively, the injectors 201, 203, each supplying the inlet 21 of the second group 20. The injectors 103, 103, 201, 203 can all be identical, identical in pairs, or all different as needed. Using several injectors in parallel advantageously makes it possible to obtain a wider range of flow rates. This also makes it possible to limit the pressure oscillations, by means of the opening/closing cycles of each injector. This also makes it possible to overcome an injector failure. This can also make it possible to increase the lifespan of an injector, as it can only be requested half the time.

This third embodiment is, in this case, illustrated with a sensor 401 downstream from the groups 10, 20, configured to regulate all of the injectors 101, 103, 201, 203, like for the second embodiment. A second sensor 403 is, in this case, provided for a question of safety: in case of failure of the sensor 401, the sensor 403 supplements the sensor 401.

In this third embodiment, the draining valve is replaced with two valves 42, 43 mounted in parallel. This enables both a redundancy and an option to modulate the draining flow rate, according to which the opening of one single or two valves 42, 43 is controlled simultaneously. The valves 42, 43 can be identical or different.

Through the examples described above, it clearly appears that the fuel cell system according to the invention, having an improved compactness, reactivity, control and reliability, is fully suitable for automotive or heavy transport applications (land, sea, air, etc.).

The invention is not limited to the embodiments described above and extends to all the embodiments covered by the invention.

In particular, the number of injectors per secondary supply line, the number of pressure sensors and the position of these pressure sensors on the fluid circuit, can vary. A person skilled in the art will know, without difficulty, adapt the number of injectors and of sensors and their positions to form a fluid circuit configuration corresponding to their needs.

Likewise, the capacity of one or more injector(s), to ensure the expansion of a relatively high upstream pressure to a downstream low pressure is dependent on the choice of the sizing of the injector and of the energy, that it is ready to be supplied with, in order to ensure its expansion cycles, and can be adapted by a person skilled in the art to the specifics of its installation. The notion of medium pressure described for the invention, can thus be greater than 50 bars, by means of suitable injectors.

Several cells, with groups of overlapped cells, can also be considered in the scope of the present invention, by implementing the injector expansion/switching principle.

1. A system of at least one fuel cell, the system comprising:
a first group of electrochemical cells having a first inlet and a first outlet,
a second group of electrochemical cells having a second inlet and a second outlet,
a fluid circuit to supply said first and second groups with a fluid, and to discharge said fluid from said first and second groups said fluid circuit comprising an upstream part, comprising:
a main supply conduit configured to drive the fluid with medium pressure, and connected to secondary supply lines,
a first secondary supply line connected to the main supply conduit (300a) and connected to the first inlet of the first group, and
a second secondary supply line connected to the main supply conduit and connected to the second inlet of the second group,
said fluid circuit comprising a downstream part, comprising:
a main discharge conduit connected to secondary discharge lines, and configured to be connected to an exhaust,
a first secondary discharge line connected to the first outlet of the first group, to the main discharge conduit, and to the second outlet of the second group, so as to enable a fluid supply of the second group via the second outlet, by the fluid having passed through the first group, and
a second secondary discharge line connected to the second outlet of the second group, to the main discharge conduit and to the first outlet of the first group, so as to enable a fluid supply of the first group via the first outlet, by the fluid having passed through the second group,
at least one expansion member located in the upstream part of the fluid circuit, configured to decrease the pressure of the fluid from the medium pressure to a low pressure,
a first switching member on the first secondary supply line configured to enable or block a flow of the fluid to the first inlet,
a second switching member on the second secondary supply line, configured to enable or block a flow of the fluid to the second inlet, and
a draining member on the main discharge conduit, configured to enable or block a flow of the fluid to the exhaust, wherein
the first switching member is formed by a first injector enabling or blocking the flow of the fluid to the first inlet, and said first injector is further configured to decrease the pressure of the fluid from the medium pressure to a first low pressure,
the second switching member is formed by a second injector enabling or blocking the flow of the fluid to the second inlet, and said second injector is further configured to decrease the pressure of the fluid from the medium pressure to a second low pressure, and
the at least one expansion member is formed by the first injector and the second injector.

2. The system according to claim 1, wherein the first and second injectors are regulated in pressure, respectively by the first and second sensors located respectively on the first and second secondary supply lines.

3. The system according to claim 1, wherein the first and second injectors are regulated in pressure by a sensor located in the downstream part of the fluid circuit.

4. The system according to claim 3, wherein the sensor is positioned, such that, for given constant supply conditions of the first group or of the second group, the sensor measures one same constant pressure.

5. The system according to claim 4, wherein the sensor is positioned at an equal distance from the first and second outlets of the first and second groups.

6. The system according to claim 3, further comprising a controller configured to control the first and second injectors according to a pressure measurement of the sensor and a pressure loss model established for the first and second groups of electrochemical cells.

7. The system according to claim 1, wherein the fluid circuit further comprises, in the upstream part:
a third secondary supply line in parallel with the first secondary supply line connected to the main supply conduit and connected to the first inlet of the first group, and
a fourth secondary supply line in parallel with the second secondary supply line, connected to the main supply conduit and connected to the second inlet of the second group, and the system further comprises:
a third injector on the third secondary supply line enabling or blocking the flow of the fluid to the first inlet, and configured to decrease the pressure of the fluid coming from the main supply conduit, from the medium pressure to a third low pressure, and
a fourth injector on the fourth secondary supply line, enabling or blocking the flow of the fluid to the second inlet, and configured to decrease the pressure of the fluid coming from the main supply conduit, from the medium pressure to a fourth low pressure.

8. The system according to claim 7, wherein the first, second, third, and fourth injectors are regulated in pressure by a sensor located on the downstream part of the fluid circuit.

9. The system according to claim 8, wherein the sensor is positioned, such that, for given constant supply conditions of the first group or of the second group, the sensor measures one same constant pressure.

10. The system according to claim 8, further comprising an additional sensor, to supplement the sensor on the downstream part of the fluid circuit.

11. The system according to claim 1, wherein the main supply conduit is connected to a first expansion member configured to decrease the pressure of the fluid coming from a reservoir storing the fluid at a pressure called high pressure, from high pressure to medium pressure.

12. The system according to claim 11, wherein the first expansion member is formed by an injector which is different from the first and second injectors.
